(19) United States
(12) Patent Application Publication
(10) Pub. No.: US 2002/0024283 A1
(43) Pub. Date: Feb. 28, 2002

(54) Shadow mask structure having shadow mask not undesirably vibrated

(75) Inventor: Shinji Arai, Tokyo (JP)

Correspondence Address: SUGHRUE, MION, ZINN,, MACPEAK & SEAS, PLLC, 2100 Pennsylvania Avenue, N.W., Washington, DC, 20037-3213, US

(73) Assignee: NEC Corporation

(21) Appl. No.: 09/934,843

(22) Filed: Aug. 23, 2001

(30) Foreign Application Priority Data
Aug. 23, 2000 (JP) 252658/2000

(51) Int. Cl. H01J 29/80

(52) U.S. Cl. 313/407

(57) ABSTRACT

A shadow mask structure to which this invention is applicable comprises a mask frame and a shadow mask. The mask frame is provided with a frame plate and a pair of major sidewalls. The frame plate has a rectangular outline-shape limited by a pair of major plate sides and a pair of minor plate sides. The major sidewalls are perpendicularly risen from the major plate sides. The shadow mask has a rectangular shape limited by a pair of major mask sides and a pair of minor mask sides. The shadow mask is spanned between the ends of the major sidewalls so as to be tensioned and so that a main surface of the shadow mask is shaped into a predetermined curvature. The shadow mask structure further comprises a pair of elastic wires. Each of the elastic wires has a fixed end region attached to the minor sidewall and a free end region touched to the minor mask side. The free end region is touched to the minor mask side at strength such that the curvature of the shadow mask is not changed.

### BACKGROUND OF THE INVENTION

This invention relates to a shadow mask structure used in a cathode-ray tube (CRT) and a color CRT using the shadow mask structure.

Recently, the color CRT in which an outer surface of a glass panel is flat is widely come into use. Such a color CRT is so called a flat color CRT. However, although the outer surface of the glass panel is flat, an inner surface of the glass panel is a part of a surface of a cylinder, that is, not flat. A first reason of this is that a pressure-resistance of the glass panel is low and the glass panel may burst if thicknesses of all areas of the glass panel are equal. A second reason is that a picture shown on the glass panel will appear unnatural and be seen like a concave if the thicknesses of all areas of the glass panel are equal. Thus, in order to prevent the glass panel from being burst and to prevent the unnatural appearance, the glass panel is made into a concave lens shape in which the central region is thin while a peripheral region is thick.

Generally, in order to achieve the uniform distances (Q-value) between the inner surface of the glass panel and the shadow mask at every locations, the shadow mask is also made in a part of a surface of the cylinder so as to correspond to the inner surface of the glass panel. The radius of the inner surface of the glass panel and the radius of the shadow mask are substantially equal.

The shadow mask structure is applied to a color flat CRT having 19 inches in a diagonal size. The shadow mask structure comprises a mask frame and a shadow mask. The mask frame is provided with a frame plate, a pair of major sidewalls, and a pair of minor sidewalls. The frame plate has a rectangular outline-shape limited by a pair of major plate sides and a pair of minor plate sides. The major sidewalls are perpendicularly risen from the major plate sides. The minor sidewalls are perpendicularly risen from the minor plate sides.

The shadow mask has a rectangular shape limited by a pair of major mask sides and a pair of minor mask sides. The major and the minor mask sides correspond to the major and the minor plate sides, respectively. By seam-welding the major mask sides to the ends of the major sidewalls, the shadow mask is spanned between the ends of the major sidewalls so as to be tensioned and so that a main surface of the shadow mask is shaped into a predetermined curvature.

The shadow mask is provided with an aperture area. The aperture area has a large number of EB (Electron Beam) passing apertures. On the other hand, a no-aperture area having no EB-passing aperture is extended at a peripheral region of the aperture area on the shadow mask. Because the ends of the major sidewalls are curved upward, the shadow mask is formed into a part of a surface of a cylinder.

The shadow mask structure is produced and assembled as follows.

Upper portions of the major sidewalls are forced inwardly by applying predetermined pressures. Consequently, the mask frame is elastic-deformed so that the major sidewalls are leaned inward. Next, the shadow mask is spanned between the ends of the major sidewalls and the major mask sides are seam-welded to the ends of the major sidewalls. Thereafter, the pressures are released from the major sidewalls. As a result, the shadow mask is always tensioned at a predetermined tension in a minor direction parallel to the minor frame sides and the minor mask sides. The shadow mask is generally tensioned in single direction as the conventional example.

As described above, only the major mask sides of the shadow mask are welded while the minor mask sides are not welded and therefore free. Furthermore, the shadow mask has comparatively large size limited by a minor side length of 280 mm and a major side length of 360 mm while a thickness of 0.1 mm, which is very thin. Therefore, the shadow mask is not sufficient in its rigidity. The shadow mask structure is typically installed in a casing with a speaker and used as a television set or a monitor apparatus. Consequently, if the shadow mask is applied with the vibration caused from the sound of the speaker, the shadow mask easily vibrates and continues to vibrate for a long time.

From experiments by the inventor, the shadow mask went on a damped vibration for approximately sixty seconds when a strong impact is once applied to the shadow mask structure. The damped vibration causes a fluctuation of the Q-value. Particularly, minor mask side regions neighboring the minor mask sides change in the Q-value and the EB diverges from an original direction. When the Q-value of the shadow mask structure changes, the color flat CRT provided with the shadow mask structure is reduced in a color-purity. Therefore, the color flat CRT provided with the shadow mask remains in a decline of the color-purity, caused by the vibration of the shadow mask, at left and right side regions of the screen.

In order to solve the above-mentioned problem, a mechanical structures for preventing the undesirable vibration in which shock absorbers or dampers are structured in a T-shape, a Z-shape, and a coil spring-shape are disclosed in Japanese Unexamined Patent Publications Nos. 77936/1996, 274867/1997, and 274868/1997 (Tokkai Hei 8-77936, 9-274867, and 9-274868), respectively. However, it is necessary for the structure to produce the shock absorber having complex structure and to accurately incorporate the shock absorber to the shadow mask structure so that the curvature of the shadow mask is not changed. Therefore, costs of parts, assembling, and adjusting are high and in addition, the weight of the shadow mask structure is increased.

Furthermore, although it is not for the shadow mask, a structure for preventing undesirable vibration of an aperture grill is disclosed. The aperture grill is also a part used in a color CRT for selecting color. The structure is disclosed in Japanese Unexamined Patent Publication No. 106449/1998 (Tokkai Hei 10-106449). In the structure, a damping wire is laid on a surface of the aperture grill so as to cross the surface. The damping wire prevents the vibration of the aperture grill. As applying the structure to the shadow mask, a damping wire may be laid on the surface of the shadow mask so that the vibration of the shadow mask can be prevented. However, because the damping wire is silhouetted against the screen, the structure using the damping wire is preferable for neither the aperture grill nor the shadow mask. Particularly, when the color CRT using the shadow mask or the aperture grill is a high precision typed display, it is not preferable to use the structure for the shadow mask or the aperture grill.

### SUMMARY OF THE INVENTION

It is therefore an object of this invention to provide a shadow mask structure capable of damping, in a short time, an undesirable vibration of a shadow mask by simple structure and low cost.

It is another object of this invention to provide a cathode-ray tube comprising the shadow mask structure mentioned above and therefore being excellent in the screen luminance and the color-purity.

The other objects, features, and advantages of this invention will become clear as the description proceeds.

This invention is directed to a shadow mask structure comprising a mask frame and a shadow mask attached to the mask frame. The mask frame is provided with a frame plate and a pair of major sidewalls. The frame plate has a rectangular outline-shape limited by a pair of major plate sides and a pair of minor plate sides. The major sidewalls are perpendicularly risen from the major plate sides. The shadow mask has a rectangular shape limited by a pair of major mask sides and a pair of minor mask sides. The major and the minor mask sides correspond to the major and the minor plate sides. The shadow mask is spanned between the ends of the major sidewalls so as to be tensioned and so that a main surface of the shadow mask is shaped into a predetermined curvature. The shadow mask structure further comprises a pair of elastic wires. Each of the elastic wires has a fixed end region attached to the minor sidewalls and a free end region touched to the minor mask side. The free end region is touched to the minor mask side at strength such that the curvature of the shadow mask is not changed.

### BRIEF DESCRIPTION OF THE DRAWINGS

FIG. 1 is a perspective view showing a conventional shadow mask structure;

FIG. 2 is a perspective view showing a shadow mask structure according to a first embodiment of this invention;

FIG. 3 is a perspective view showing a shadow mask structure according to a second embodiment of this invention; and

FIG. 4 is a perspective view showing a shadow mask structure according to a third embodiment of this invention.

### DESCRIPTION OF THE PREFERRED EMBODIMENTS

In order to facilitate an understanding of this invention, description will at first be made with reference to the drawings about conventional shadow mask structure of a type described in the preamble of this specification.

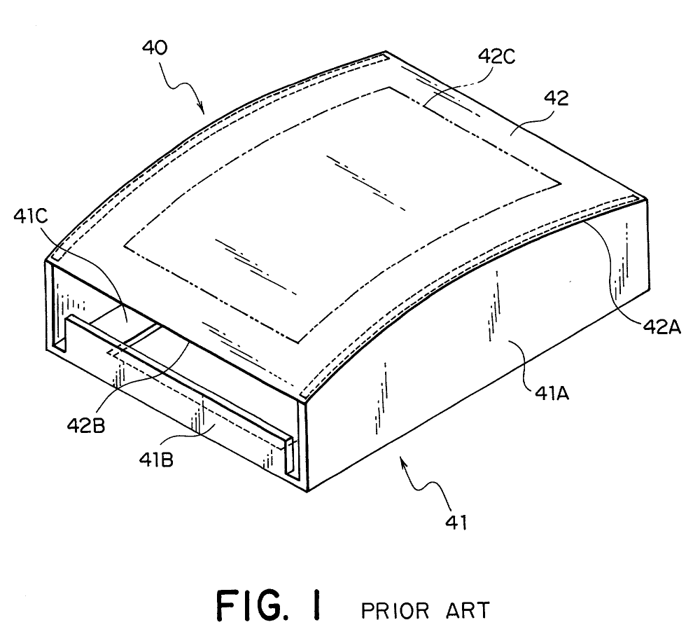

FIG. 1 shows, as an example of a conventional shadow mask structure, a shadow mask structure 40 applied to a color flat CRT having 19 inches in a diagonal size.

Referring to FIG. 1, a general size of the shadow mask structure 40 is a major side: 360 mm, a minor side: 270 mm, and the maximum height: 40 mm. The shadow mask structure 40 comprises a mask frame 41 and a shadow mask 42 attached to the mask frame 41. The mask frame 41 is provided with a frame plate 41C, a pair of major sidewalls 41A, and a pair of minor sidewalls 41B. The frame plate 41C has a rectangular outline-shape limited by a pair of major plate sides and a pair of minor plate sides. The major sidewalls 41A are perpendicularly risen from the major plate sides. The minor sidewalls 41B are perpendicularly risen from the minor plate sides.

The shadow mask 42 has a rectangular shape limited by a pair of major mask sides 42A and a pair of minor mask sides 42B. The major and the minor mask sides 42A and 42B correspond to the major and the minor plate sides. By seam-welding the major mask sides 42A to the ends of the major sidewalls 41A, the shadow mask 42 is spanned between the ends of the major sidewalls 41A so as to be tensioned and so that a main surface of the shadow mask is shaped into a predetermined curvature. In FIG. 1, seam-welded areas are shown by dashed squares.

The shadow mask 42 is provided with an aperture area 42C (limited by a two-dot dashed line in FIG. 1). The aperture area 42C is extended on the central rectangular region of the shadow mask 42. The aperture area 42C has a large number of EB (Electron Beam)-passing apertures. On the other hand, a no-aperture area having no EB-passing aperture is extended at a peripheral region of the aperture area 42C on the shadow mask 42. Because the ends of the major sidewalls 41A are curved upward, the shadow mask 42 is formed into a part of a surface of a cylinder.

The shadow mask structure 40 is produced and assembled as follows.

Upper portions of the major sidewalls 41A are forced inwardly by applying predetermined pressures. Consequently, the mask frame 41 is elastic-deformed so that the major sidewalls are leaned inwardly. Next, the shadow mask 42 is spanned between the ends of the major sidewalls 41A and the major mask sides 42A are seam-welded to the ends of the major sidewalls 41A. After that, the pressures are released from the major sidewalls 41A. As a result, the shadow mask 42 is always tensioned at the predetermined tension in a minor direction parallel to the minor frame sides and minor mask sides 42B. Because the shadow mask 42 formed as a part of the cylinder, it is difficult to tension in two directions. Therefore, the shadow mask is generally tensioned in single direction as the conventional example.

The mask frame 41 is made by pressing and bending a 13-chromium stainless steel plate except the major sidewalls 41A. The 13-chromium stainless steel is high-rigidity metal. On the other hand, the shadow mask 42 and the major sidewalls 41A are made of Invar. The Invar is low-thermal expansion coefficient metal. The reason why the shadow mask 42 is made of Invar although the Invar is comparatively expensive is that the Invar has low-thermal expansion coefficient. On the other hand, the reason why the major sidewalls 41A are also made of Invar although the Invar is comparatively expensive is as follows. Namely, if expansion coefficients of the shadow mask 42 and the major sidewalls 41A are equal to each other, the shadow mask 42 is prevented from warping when the major sidewalls 41 are thermal-expanded.

As described above, only the major mask sides 42A of the shadow mask 42 are welded while the minor mask sides 42B are not welded and therefore free. Furthermore, the shadow mask 42 has comparative large size limited by a minor side length of 280 mm and a major side length of 360 mm while very thin thickness of 0.1 mm. Therefore, the shadow mask is not high-rigidity. Consequently, if the shadow mask 42 is applied vibration caused from a speaker, the shadow mask 42 easily vibrates and continues to vibrate for a long time.

From experiments by the inventor of this invention, the shadow mask 42 went on a damped vibration for approximate sixty seconds when comparative strong impact is applied to the shadow mask structure 40 at once. The damped vibration causes a fluctuation of the Q-value. Particularly, minor mask side regions neighboring the minor mask sides 42B very change in the Q-value and the EB very diverges from an original direction. When the Q-value of the shadow mask structure changes, the color flat CRT provided with the shadow mask structure is reduced in a color-purity. Therefore, the color flat CRT provided with the shadow mask 42 remains in a decline of the color-purity, caused by the vibration of the shadow mask 42, at left and right side regions of the screen.

Now, preferred embodiments of this invention will be described with reference drawings.

First Embodiment

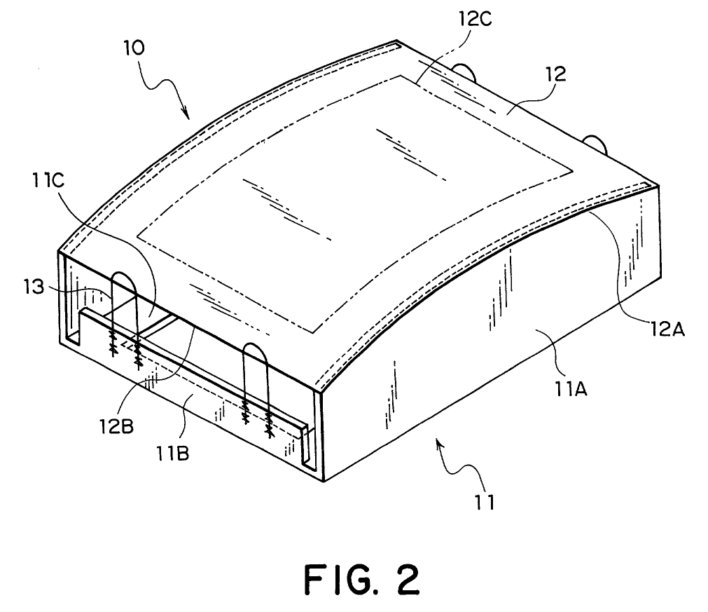

Referring to FIG. 2, a shadow mask structure 10 according to a first embodiment of this invention is, as like to the conventional structure shown in FIG. 1, applied to a color flat CRT having the diagonal size of 19 inches. The shadow mask structure 10 has similar parts designated by similar reference numerals that are illustrated in FIG. 1. Therefore, description for the similar parts of the shadow mask structure 10 is omitted. A general size of the shadow mask structure 10 is a major side: 360 mm, a minor side: 270 mm, and the maximum height: 40 mm.

The shadow mask structure 10 comprises a mask frame 11 and a shadow mask 12. The mask frame 11 is provided with a frame plate 1C, a pair of major sidewalls 11A, and a pair of minor sidewalls 11B. The frame plate 11C has a rectangular outline-shape limited by a pair of major plate sides and a pair of minor plate sides. The major sidewalls 11A are perpendicularly risen from the major plate sides. The minor sidewalls 11B are perpendicularly risen from the minor plate sides. The shadow mask 12 has a rectangular shape limited by a pair of major mask sides 12A and a pair of minor mask sides 12B. The major and the minor mask sides 12A and 12B correspond to the major and the minor plate sides. By seam-welding the major mask sides 12A to the ends of the major sidewalls 11A, the shadow mask 12 is spanned between the ends of the major sidewalls 11A so as to be tensioned and so that a main surface of the shadow mask is shaped into a predetermined curvature. In FIG. 2, seam-welded areas are shown by dashed squares. The shadow mask 12 is provided with an aperture area 12C (limited by a two-dot dashed line). The aperture area 12C is extended on the central rectangular region of the shadow mask 12. The aperture area 12C has a large number of EB-passing apertures not shown. On the other hand, a no-aperture area having no EB-passing aperture is extended at a peripheral region of the aperture area 12C on the shadow mask 12. Because the ends of the major sidewalls 11A are curved upward, the shadow mask 12 is formed into a part of a surface of a cylinder.

The shadow mask structure 10 is produced and assembled as follows. Upper portions of the major sidewalls 11A are forced inwardly by applying predetermined pressures. Consequently, the mask frame 11 is elastic-deformed so that the major sidewalls 11A are leaned inwardly. Next, the shadow mask 12 is spanned between the ends of the major sidewalls 11A and the major mask sides 12A are seam-welded to the ends of the major sidewalls 11A. After that, the pressures are released from the major sidewalls 11A. As a result, the shadow mask 12 is always tensioned at the predetermined tension in a minor direction parallel to the minor frame sides and minor mask sides 12B. The mask frame 11 is made by pressing and bending a 13-chromium stainless steel plate except the major sidewalls 11A. The 13-chromium stainless plate has a thickness of 2.2 mm. On the other hand, the shadow mask 12 and the major sidewalls 11A are made of Invar. A thickness of the shadow mask 12 is 100 μm. A thickness of the major sidewall 11A is 2.2 mm.

Advantage of the shadow mask structure 10 of the first embodiment is that the shadow mask structure 10 further comprises two pairs of elastic wires 13. Each of the elastic wires 13 is provided with a fixed end region attached to the minor sidewall 11B and a free end region touched to the minor mask side 12B. The free end region is touched to the minor mask side 12B at strength such that the curvature of the shadow mask 12 is not changed. The elastic wire 13 is made by a phosphor bronze wire and has a diameter of 0.5 mm. In the first embodiment, the elastic wire 13 is touched to the minor mask side 12B at two points.

The elastic wire 13 may be made from at least one material selected from spring steel, the phosphor bronze, nickel silver, beryllium bronze, silver-copper metal, and chromium-copper metal.

The elastic wire 13 is attached to the shadow mask structure 10 as follows. An elastic wire member shaped into a U-shape is prepared. The elastic wire member is welded to the minor sidewall 11B of the mask frame 11 at four points (represented by an X-symbol in FIG. 2). Instead of this, the elastic wire 13 can be also attached as follows. An elastic wire of long length is welded to the minor side wall 11B, shaped into the U-shape, welded to the minor side wall 11B, and cut up with being supplied to the mask frame 11.

In the shadow mask structure 10, vibration energy of the shadow mask 12 is changed or made into thermal energy caused by friction between the minor mask sides 12B of the shadow mask 12 and the elastic wires 13. Consequently, the vibration energy of the shadow mask 12 is quickly and efficiently damped or absorbed.

From experiments by the inventor, the shadow mask 12 went on a damped vibration for approximate six seconds when the same strength impact applied to the conventional structure 40 is applied to the shadow mask structure 40. Namely, a lasting period of the damped vibration is cut to one tenth of the shadow mask structure 10. This is because the vibration of the shadow mask 12 is efficiently absorbed and damped by a friction between the shadow mask 12 and the elastic wires 13. When the lasting period is as shortened as this, decline of the color-purity is not recognized and troubled practically.

Second Embodiment

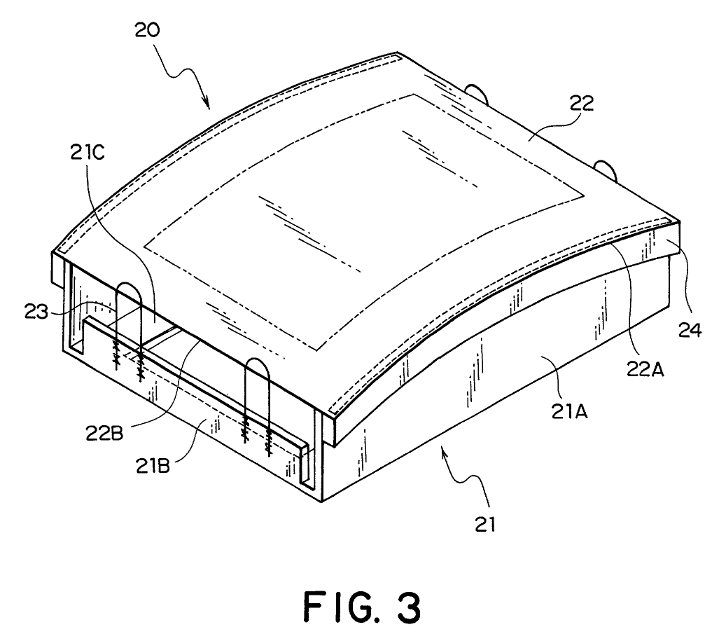

Referring to FIG. 3, a shadow mask structure 20 according to a second embodiment of this invention has similar parts designated by similar reference numerals that are illustrated in FIG. 2. Therefore, description for the similar parts of the shadow mask structure 20 is omitted.

Advantage of the second embodiment is that the shadow mask structure 20 comprises a pair of mask supporting beams 24 attached to the end and outer regions of major sidewalls 21A. A shadow mask 22 is spanned between the upper ends of the mask supporting beams 24 so as to be indirectly spanned between the ends of the major sidewalls 21A through the mask supporting beams 24.

The mask supporting beam 24 is made essentially of low-thermal expansion coefficient metal. Concretely, the mask supporting beam 24 is made from an Invar plate having the width of 15 mm and the thickness of 3.0 mm. The mask frame 21 is made by pressing and bending a 13-chromium stainless steel plate. The 13-chromium stainless plate has thickness of 2.2 mm.

The shadow mask 22 has a rectangular shape corresponding to a frame plate 21C of a mask frame 21. The shadow mask 22 is made of Invar. The shadow mask 22 is spanned between the ends of the mask supporting beams 24 so as to be tensioned. The shadow mask 22 is seam-welded on the ends of the mask supporting beams 24 (represented by dashed lines in FIG. 3). The ends of the mask supporting beams 24 are located at the same level as the ends of the main sidewalls 21A.

It is not to say, the supporting beams 24 and the shadow mask 22 are equal to one another in thermal expansion coefficient.

As like to the shadow mask structure 10, the shadow mask structure 20 also comprises two pairs of elastic wires 23. Each of the elastic wires 23 is provided with a fixed end region attached to a minor sidewall 21B and a free end region touched to a minor mask side 22B. The free end region is touched to the minor mask side 22B at strength such that the curvature of the shadow mask is not changed. The elastic wire 23 is made by a phosphor bronze wire and has the diameter of 0.5 mm. The elastic wire 23 can be attached to the mask frame 21 as like to the elastic wire 13 in the first embodiment.

In the second embodiment, because the mask supporting beams 24 are made of Invar as the same as the shadow mask 22, the shadow mask 22 is prevented from warping if the mask frame 21 and the major sidewalls 21A are thermal-expanded. Although the Invar is comparatively expensive, the shadow mask structure 20 can be produced by lower cost than the shadow mask structure 10 because the use amount for the mask supporting beams 24 is less than that of the major sidewalls 21A. Effect for damping vibration of the shadow mask 22 by the elastic wires 23 is equal to the effect in the first embodiment.

Third Embodiment

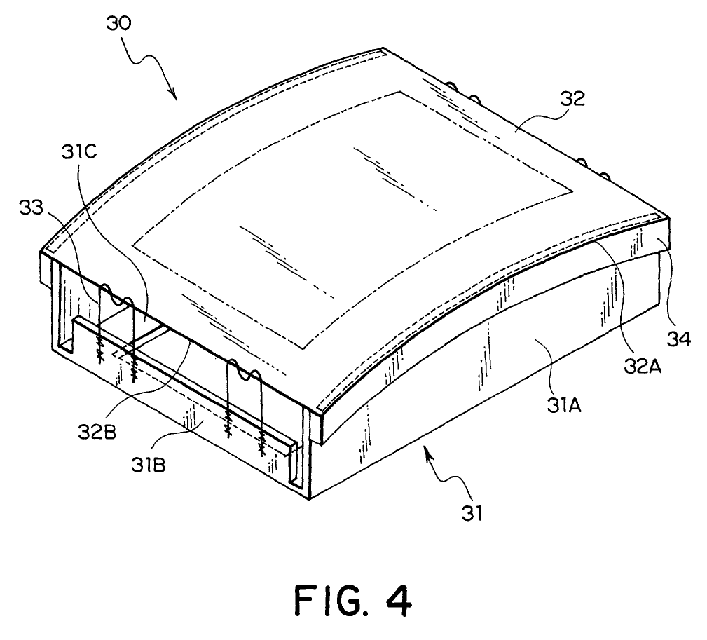

Referring to FIG. 4, a shadow mask structure 30 according to a third embodiment of this invention has similar parts designated by similar reference numerals that are illustrated in FIG. 3. Therefore, description for the similar parts of the shadow mask structure 30 is omitted.

Advantage of the third embodiment is that each of elastic wires 33 has an M or W-shape. Each of the elastic wire 33 is touched to a minor mask side 32B of a shadow mask 32 at four points as two times number of the second embodiment. Consequently, in order to provide damping effect as same as the second embodiment, touching strength at one point is half of that of the second embodiment. Thus, the shadow mask structure 30 can make the curvature of the shadow mask 32 not changed more efficiently than the second embodiment.

While this invention has thus far been described in conjunction with a few embodiments thereof, it will readily be possible for those skilled in the art to put this invention into practice in various other manners.

What is claimed is:

1. A shadow mask structure comprising a mask frame and a shadow mask attached to said mask frame, said mask frame being provided with a frame plate, a pair of major sidewalls, and a pair of minor sidewalls, said frame plate having a rectangular outline-shape limited by a pair of major plate sides and a pair of minor plate sides, said major sidewalls being perpendicularly risen from said major plate sides, said minor sidewalls being perpendicularly risen from said minor plate sides, said shadow mask having a rectangular shape limited by a pair of major mask sides and a pair of minor mask sides, said major and said minor mask sides corresponding to said major and said minor plate sides, said shadow mask being spanned between the ends of said major sidewalls so as to be tensioned and so that a main surface of said shadow mask is shaped into a predetermined curvature;
wherein said shadow mask structure further comprises a pair of elastic wires;
each of said elastic wires having a fixed end region attached to said minor sidewall and a free end region touched to said minor mask side;
said free end region being touched to said minor mask side at strength such that the curvature of said shadow mask is not changed.

2. A shadow mask structure as claimed in claim 1, wherein said shadow mask structure further comprises a pair of mask supporting beams attached to the end and outer regions of said major sidewalls;
said shadow mask being spanned between the ends of said mask supporting beams so as to be indirectly spanned between the ends of said major sidewalls through said mask supporting beams.

3. A shadow mask structure as claimed in claim 2, wherein said mask supporting beams and said shadow mask are substantially equal to one another in thermal expansion coefficient.

4. A shadow mask structure as claimed in claim 3, wherein said mask supporting beams and said shadow mask are made from Invar-metal.

5. A shadow mask structure as claimed in claim 1, wherein said elastic wire is made from at least one material selected from spring steel, phosphor bronze, nickel silver, beryllium bronze, silver-copper metal, and chromium-copper metal.

6. A color cathode-ray tube comprising a shadow mask structure as claimed in claim 1.
